(19) United States
(12) Patent Application Publication
(10) Pub. No.: US 2017/0282813 A1
(43) Pub. Date: Oct. 5, 2017

(54) IMAGE DISPLAY CONTROL DEVICE AND IMAGE DISPLAY SYSTEM

(71) Applicant: AISIN SEIKI KABUSHIKI KAISHA, Kariya-shi, Aichi (JP)

(72) Inventor: Yoshikuni HASHIMOTO, Anjo-shi, Aichi-ken (JP)

(73) Assignee: AISIN SEIKI KABUSHIKI KAISHA, Kariya-shi, Aichi (JP)

(21) Appl. No.: 15/507,792

(22) PCT Filed: Aug. 21, 2015
(86) PCT No.: PCT/JP2015/073579

§ 371 Date: Mar. 1, 2017

(30) Foreign Application Priority Data
Sep. 5, 2014 (JP) 2014-181774

(51) Int. Cl. B60R 11/04; G08G 1/16

(52) U.S. Cl. CPC B60R 11/04; G08G 1/165; G08G 1/166; G08G 1/168; B60R 2300/70; B60R 2300/8046

(57) ABSTRACT

An image display control device according to an embodiment includes an image generator configured to generate a display image to be displayed on a display device, the display image containing a vehicle exterior image based on at least a part of a captured image by an imager an imaging area of which is from a direction in which a rear end of a vehicle body can be captured to a direction upward from a horizontal direction and a rearward of a vehicle; an area changer configured to change an area of the captured image to be contained in the display image for forward travel and backward travel of the vehicle; and a display controller configured to control the display device to display the display image.

### TECHNICAL FIELD

Embodiments of the present invention relate to an image display control device and an image display system.

### BACKGROUND ART

Conventionally, image processors for vehicles that create and display an image with transparent pillars as viewed from vehicle interior have been known.

Patent Document 1: Japanese Patent Application Laid-open No. 2003-196645

### DISCLOSURE OF INVENTION

### Problem to be Solved by the Invention

It is significant to provide such a type of an image display control device and an image display system capable of displaying an image in a less inconvenient display mode during forward travel and backward travel of a vehicle, for example.

### Means for Solving Problem

According to an embodiment, for example, an image display control device includes an image generator, an area changer, and a display. The image generator is configured to generate a display image to be displayed on a display device, the display image containing a vehicle exterior image based on at least a part of a captured image by an imager, an imaging area of the imager being from a direction in which a rear end of a vehicle body can be captured to a direction upward from a horizontal direction and a rearward of a vehicle. The area changer is configured to change an area of the captured image to be contained in the display image for forward travel and backward travel of the vehicle. The display controller is configured to control the display device to display the display image. According to this embodiment, for example, the display device can display a display image of an appropriate area for each of the forward travel and the backward travel of the vehicle.

The captured image is captured by one imager. This can thus further simplify an image display system, for example.

The image display control device includes an image corrector configured to correct the vehicle exterior image in different modes for the forward travel and the backward travel of the vehicle. For example, the display device can thus display a display image in an appropriate display mode for each of the forward travel and the backward travel of the vehicle.

In the image display control device, for example, the area changer changes a size of the area for the forward travel and the backward travel of the vehicle. For example, the display device can thus display a display image of an appropriate size for each of the forward travel and the backward travel of the vehicle.

In the image display control device, for example, the image generator is capable of generating the display image containing a plurality of the vehicle exterior images having different areas. For example, the display device can display the display image containing multiple vehicle exterior images.

In the image display control device, for example, The display device is covered by a half mirror. The display controller controls the display device to display the display image on a part of the display device, and blacken out another part of the display device to cause the half mirror to function as a mirror. The display device can be utilized as, for example, a display and a mirror.

According to one embodiment, for example, image display system includes an imager, a display device, and an image display control device. An imaging area of the imager is from a direction in which a rear end of a vehicle body can be captured to a direction upward from a horizontal direction and a rearward of a vehicle. The image display control device includes an image generator, an area changer, and a display controller. The image generator is configured to generate a display image to be displayed on the display device, the display image containing a vehicle exterior image based on at least a part of a captured image by the imager. The area changer is configured to change an area of the captured image to be contained in the display image for forward travel and backward travel of the vehicle. The display controller is configured to control the display device to display the display image. According to this embodiment, for example, the display device can display a display image of an appropriate area for each of the forward travel and the backward travel of the vehicle.

### BRIEF DESCRIPTION OF DRAWINGS

FIG. 1 is an exemplary schematic configuration diagram of an image display system according to an embodiment;

FIG. 2 is a view illustrating an example of a display image by the image display system in the embodiment;

FIG. 3 is a view illustrating another example of the display image by the image display system in the embodiment;

FIG. 4 is a plan view illustrating an example of an imaging area of an imager of the image display system in the embodiment;

FIG. 5 is a side view illustrating the example of the imaging area of the imager of the image display system in the embodiment;

FIG. 6 is a view illustrating an example of a vehicle exterior image contained in the display image by the image display system in the embodiment;

FIG. 7 is a view illustrating an example of a vehicle body image that is added by the image display system in the embodiment;

FIG. 8 is a plan view illustrating another example of the imaging area of the imager of the image display system in the embodiment;

FIG. 9 is a side view illustrating another example of the imaging area of the imager of the image display system in the embodiment;

FIG. 10 is a view illustrating an example of a display area in the vehicle exterior image by the image display system in the embodiment;

FIG. 11 is an exemplary block diagram of an electronic control unit (ECU) included in the image display system in the embodiment;

FIG. 12 is an exemplary flowchart of procedure of the image display system in the embodiment;

FIG. 13 is a view illustrating an example of a captured image by the image display system in the embodiment;

FIG. 14 is a view illustrating an example of a captured image distortion-corrected by the image display system in the embodiment;

FIG. 15 is a view illustrating an example of a captured image distortion-corrected and viewpoint-converted by the image display system in the embodiment;

FIG. 16 is a schematic plan view illustrating an example of a display mode of the display image by the image display system in the embodiment;

FIG. 17 is a schematic plan view illustrating another example of the display mode of the display image by the image display system in the embodiment;

FIG. 18 is a schematic plan view illustrating still another example of the display mode of the display image by the image display system in the embodiment;

FIG. 19 is an exemplary conceptual view illustrating a parking position of a vehicle and a display image at the position by the image display system in the embodiment and illustrating a state of the vehicle before reaching a target parking position;

FIG. 20 is a schematic plan view illustrating still another example of the display mode of the display image by the image display system in the embodiment;

FIG. 21 is a schematic plan view illustrating still another example of the display mode of the display image by the image display system in the embodiment;

FIG. 22 is an exemplary perspective view of a display device of the image display system in the embodiment;

FIG. 23 is a view illustrating still another example of the display image by the image display system in the embodiment;

FIG. 24 is a view illustrating still another example of the display image by the image display system in the embodiment; and

FIG. 25 is a view illustrating still another example of the display image by the image display system in the embodiment.

### BEST MODE FOR CARRYING OUT THE INVENTION

Hereinafter, exemplary embodiment and modifications of the present invention are disclosed. The configurations of the embodiment and the modifications, and actions, results, and effects provided by the configurations, which will be described below, are merely exemplary. The present invention can also be implemented by other configurations than those disclosed in the following embodiment and modifications. The present invention can bring at least one of various effects and secondary effects provided by the configurations.

Furthermore, the embodiment and examples, which will be disclosed below, include same or like components. Hereinafter, common reference numerals denote the same or like components and overlapped description thereof is omitted.

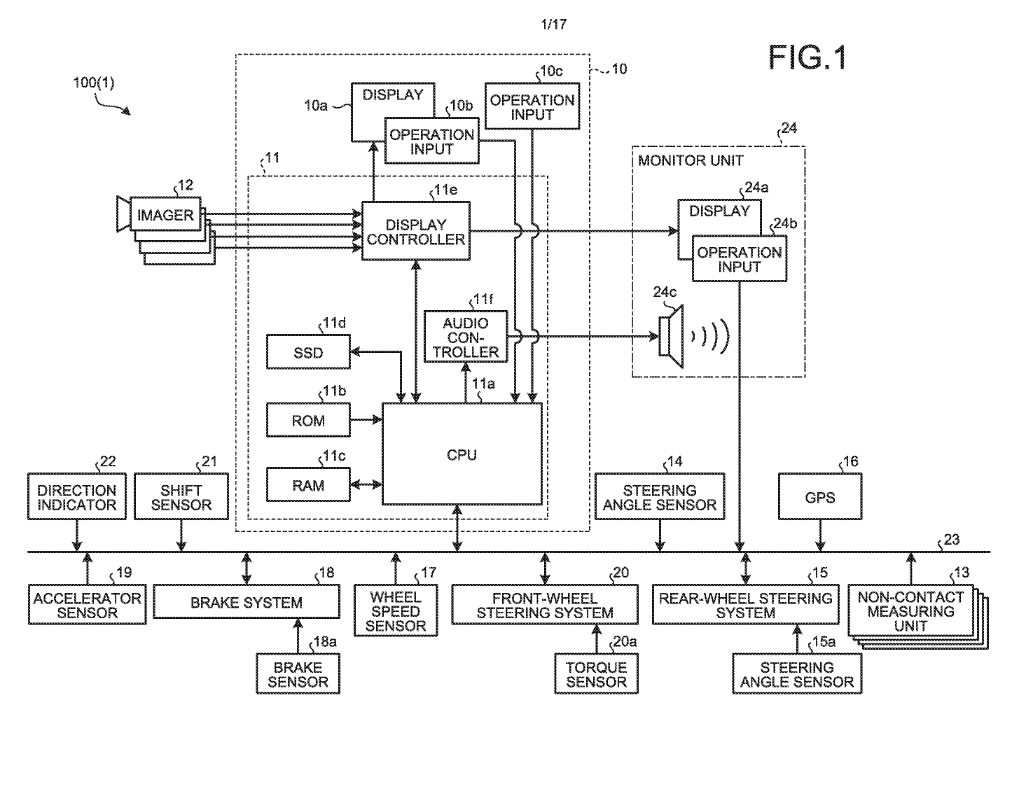

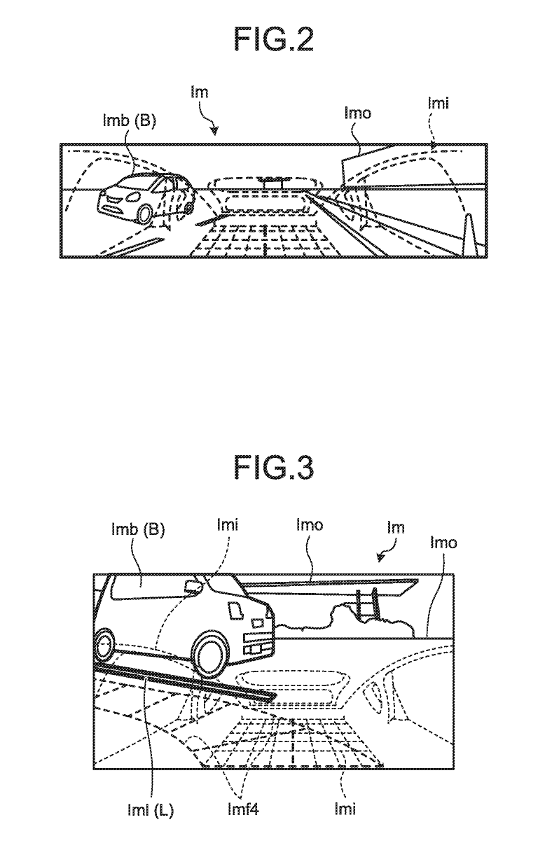

An image display system 100 installed in a vehicle 1 includes an electronic control unit (ECU) 11 that controls images displayed on a display 10a as a display device, as illustrated in FIG. 1. The ECU 11 is an example of a display controller or an image display control device. The display 10a is provided instead of, for example, a room mirror (not illustrated) provided on an upper front of a vehicle cabin. The display 10a displays an image similar to a mirror image reflected onto the room mirror on the upper front of the vehicle cabin as illustrated in FIG. 2, based on an image captured by an imager 12. An occupant such as a driver can use the display 10a as the room mirror or instead of the room mirror. The room mirror can also be referred to as a back mirror.

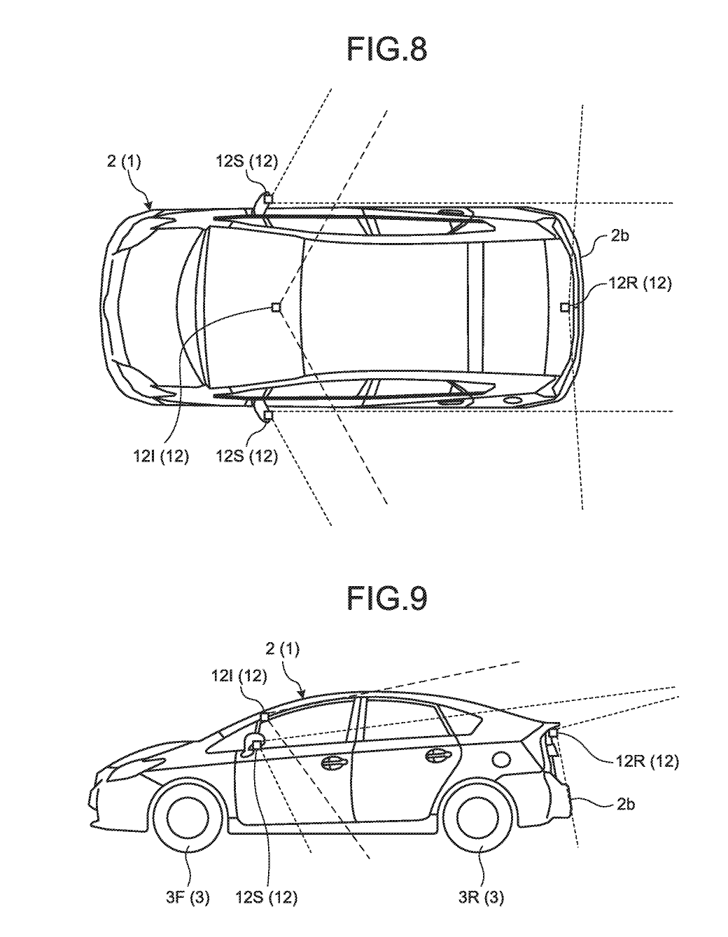

In the vehicle 1 provided with the room mirror, the display 10a in a housing 10 can be mounted on the room mirror with a mounting tool or an attachment, covering the mirror surface of the room mirror, for example. The display 10a displays a horizontally reverse image or a mirror image of the image captured by the imager 12 provided outside the vehicle or the vehicle cabin. The display 10a can be configured as, for example, a liquid crystal display (LCD), an organic electro-luminescent display (OELD), or a projector. The ECU 11 may be accommodated in the housing 10 of the display 10a or in the housing 10 provided separately from the display 10a. A half mirror (not illustrated) may be provided on the front surface or the rear side of the display 10a. In this case, the half mirror can be used as a room mirror during no use of the image display system 100 and no display of image on the display 10a. A part of the half mirror, which covers a region of the display 10a that does not display an image, for example, a blackout region, can be used as a room mirror. The housing 10 may include an imager 121 that captures images of inside the cabin as illustrated in FIGS. 8 and 9.

As illustrated in FIGS. 2 and 3, an output image Im to be displayed on the display 10a contains a vehicle exterior image Imo indicated by solid lines and a vehicle body image Imi indicated by dashed lines. The vehicle exterior image Imo can be generated from one or two or more images captured by one or two or more imagers 12. The output image Im can also be referred to as a display image. The vehicle exterior image Imo, that is, the image(s) captured by the imager(s) 12 can also be referred to as a captured image(s). The vehicle body image Imi can also be referred to as an additional image. In FIG. 2 and other drawings, in order to distinguish the vehicle body image Imi from the vehicle exterior image Imo, the vehicle exterior image Imo is indicated by the solid lines and the vehicle body image Imi is indicated by the dashed lines for convenience. The actual vehicle exterior image Imo is not limited to the one indicated by the solid lines and the vehicle body image Imi is not limited to the one indicated by the dashed lines.

The imagers 12 are digital cameras incorporating imaging elements such as charge coupled devices (CCD) or CMOS image sensors (CIS). The imagers 12 can output image data or moving image data at a predetermined frame rate.

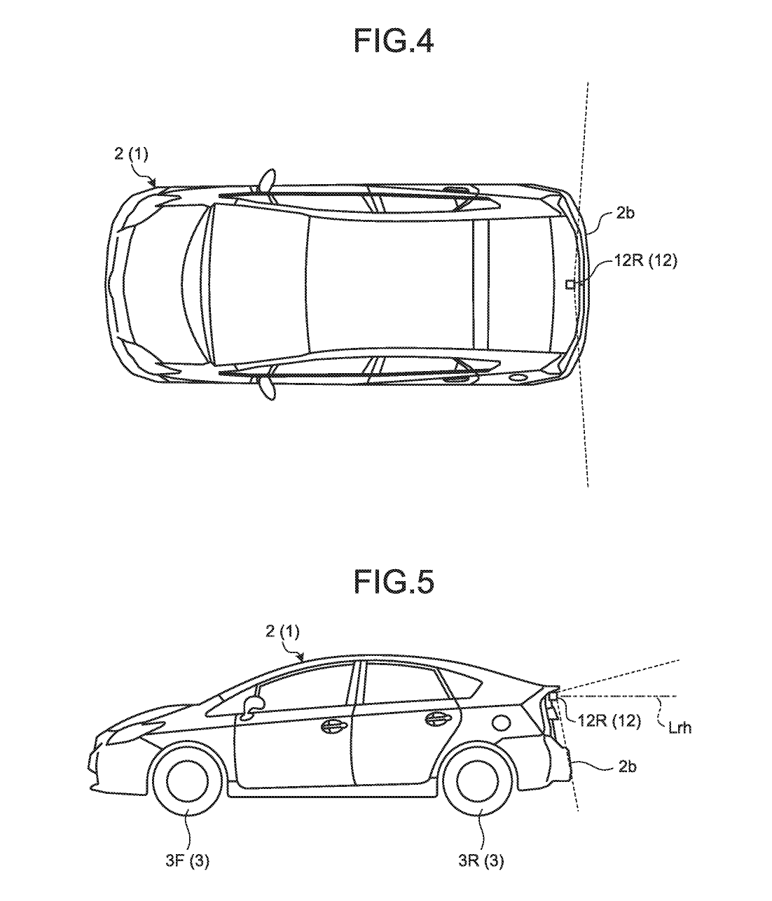

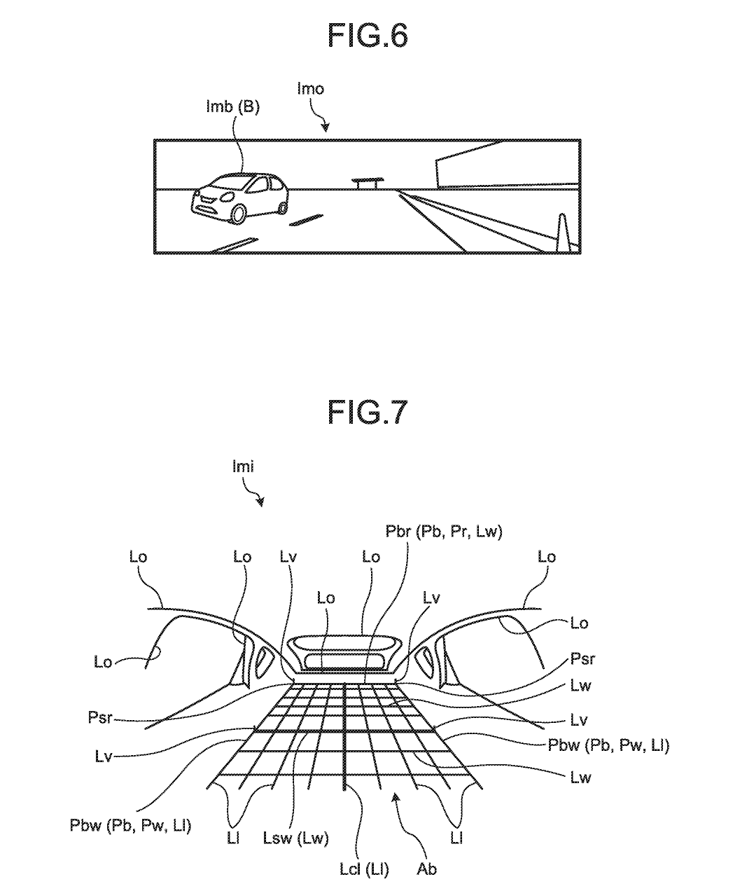

In an example of FIGS. 4 and 5, a vehicle body 2 includes, as the imagers 12 that image outside the vehicle, only an imager 12R on a rear part. The imager 12R captures images of the rear and lateral sides of the vehicle 1, that is, the rear and lateral sides of outside the vehicle cabin. The imager 12R is, for example, a wide-angle lens or a fisheye lens. In this case, an imaging area of the imager 12R is set so as to include at least an area from a direction in which a rear end 2b of the vehicle body 2 can be captured to a direction upward from a horizontal direction Lrh and a rearward of the vehicle 1, as indicated by dashed lines in FIG. 5. Thereby, an image of behind a running vehicle and an image of the vicinity of the road surface behind a parking vehicle can be provided from the captured image by the imager 12R. FIGS. 4 and 5 merely show an example of the imaging area and the imaging area of the imager 12R is not limited to the example illustrated in FIGS. 4 and 5. FIG. 6 illustrates an example of the vehicle exterior image Imo obtained from the captured image by the imager 12. The horizontal direction Lrh herein is a horizontal direction with reference to the vehicle 1 disposed on a horizontal plane.

FIGS. 2, 3, and 7 show examples of the vehicle body image Imi containing contour lines Lo or edges as display elements representing the structure of the vehicle body 2 in a three-dimensional frame form. Components of the vehicle body indicated by the contour lines Lo are, for example, corners, edges, windows, pillars, doors, floor, ceiling, trims, wheels, axles, and differential gears of the vehicle body 2. The vehicle body image Imi does not have to represent the shape of the vehicle body as long as the occupant can roughly recognize the position and the shape of the vehicle body 2 from the vehicle body image Imi. The vehicle body image Imi may be a schematic image. Regions between the contour lines Lo may be colored while the vehicle exterior image Imo is transparent.

FIGS. 2, 3, and 7 show examples of a line drawing (line view) of the vehicle body image Imi. Lines of the line drawing as display elements can be represented in various display modes. Examples of the display mode include type, surface density, width, thickness, concentration, transmittance, color, and pattern. Examples of the type include a solid line, a dashed line, a chain line, a two-dot chain line, a broken line, a jagged line, and a wavy line. The surface density refers to the density of a screen or an image per unit area. For example, the surface density of the solid line is larger than the surface density of the dashed line when they have the same thickness. The line drawing can locally contain lines in different display modes. The line drawing can partially contain dots, symbols, characters, and figures. The display modes of the line drawing can be set or changed in accordance with a traveling state and an operation state of the vehicle, for example.

As illustrated in FIGS. 2 and 3, the occupant can recognize relative positions between the vehicle 1 and an object B outside the vehicle, a distance between the vehicle 1 and the object B, the direction of the object B, and the size of the object B from the output image Im displayed on the display 10a, containing the vehicle exterior image Imo and the vehicle body image Imi. The vehicle body image Imi can contain, as illustrated in FIGS. 2, 3, and 7, parts Pw indicating width ends of the vehicle body 2, a part Pr indicating a rear end of the vehicle body 2, and parts Pb indicating a lower part of the vehicle body 2. The vehicle body image Imi can further contain parts Pbw representing width ends of the lower part of the vehicle body 2, a part Pbr representing a rear end of the lower part of the vehicle body 2 in the vehicle longitudinal direction and parts Psr representing rear side ends of the vehicle body 2 in the vehicle longitudinal direction. The vehicle body image Imi is created such that at least the lower part of the vehicle body 2 is recognizable in a planar manner or two-dimensionally. The occupant can therefore recognize, for example, the planar size, shape, and sites of the vehicle body 2. The occupant can recognize, for example, the size and height of the object B outside the vehicle cabin and the horizontal position of the object B, with reference to the vehicle body image Imi.

A non-volatile storage pre-stores therein the vehicle body image Imi. The storage can store therein vehicle body images Imi of different vehicle types. In this case, the vehicle body image Imi selected based on, for example, the type of the vehicle 1 and preferences of a user can be used for a composite image. The storage may be, for example, a solid state drive (SSD) 11d illustrated in FIG. 1. The ECU 11 can deform the vehicle body image Imi based on an input instruction or an operation to an operation input 10b in a setting such as calibration. To be specific, the vehicle body image Imi is deformed or changed in position. For example, the vehicle body image Imi is horizontally or vertically extended more greatly toward the upper side or is changed in vertical and horizontal positions. In this case, the changed vehicle body image Imi is stored in the storage and used for a composite image. The vehicle body image Imi may be an interior image captured by the imager 121 as illustrated in FIG. 8 or an altered image of the interior image.

The ECU 11 can set or change the transmittance α of the vehicle body image Imi, that is, a composite ratio between the image Imi and the vehicle exterior image Imo. For a relatively simple example, luminance x of each point of a composite image of the vehicle exterior image Imo and the vehicle body image Imi when aligned with each other can be expressed by an equation of x=(1−α)×x1+α×x2 where x1 represents the luminance of the vehicle body image Imi, x2 represents the luminance of the vehicle exterior image Imo, and α (0≦α≦1) represents transmittance. The transmittance α can be set to an arbitrary value.

FIGS. 8 and 9 show an example that the vehicle body 2 includes, as the imagers 12, imagers 12S that image lateral sides of the vehicle 1 or of outside the vehicle cabin, and the imager 12R that captures images of the rear side of the vehicle 1 or of outside the vehicle cabin. Each of the imagers 12S and 12R may capture an image containing both of the rear side and the lateral side(s) of the vehicle 1. The imagers 12S are provided on the right and left sides of the vehicle body 2 and the imager 12R is provided on the rear end 2b of the vehicle body 2. The imagers 12S can be provided on, for example, door mirrors, and the imager 12R can be provided on, for example, a rear hatch. Although not illustrated in the drawings, the imagers 12 may be provided on the right and left edges of the rear end 2b of the vehicle body 2. Furthermore, the imager 12 that captures images of at least one of the interior and the exterior of the vehicle cabin may be provided in the vehicle cabin. In the case of using the two or more imagers 12, the imaging areas of the respective imagers 12 may vertically differ from each other. Each of the imagers 12 may be a wide-angle lens or a fisheye lens.

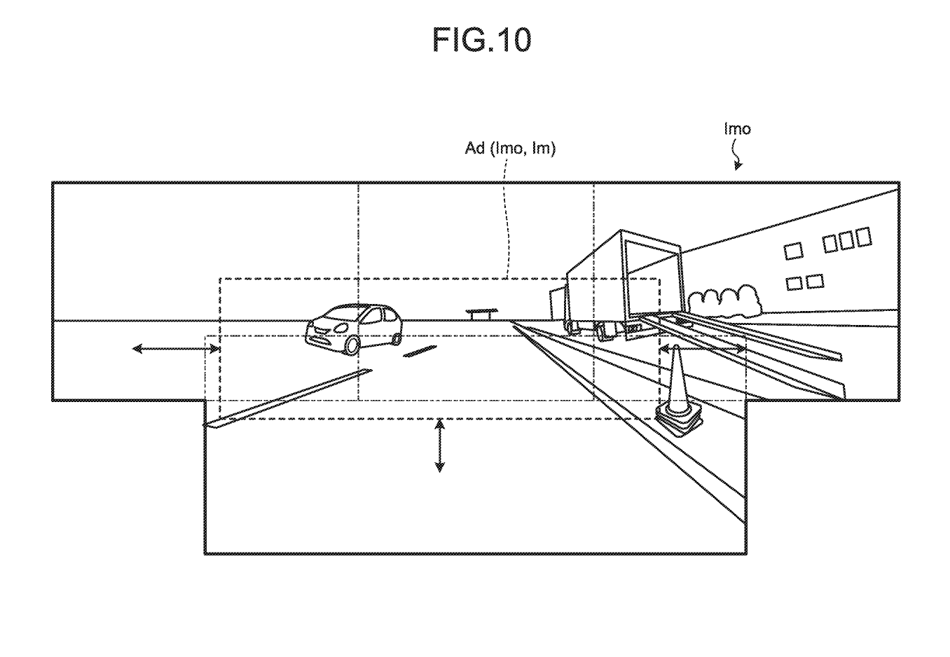

As illustrated in FIGS. 8 and 9, in the case of the two or more imagers 12 provided on the vehicle body 2, the ECU 11 can obtain a series of vehicle exterior images Imo as illustrated in FIG. 10 by combining the images acquired by the imagers 12 by a well-known technique. The vehicle exterior image Imo may be a panoramic image. In this case, the imagers 12 image a relatively large area at the rear side and the lateral sides of the vehicle 1, to be able to display the vehicle exterior image Imo captured at each position on the relatively large area of the display 10a. Then, as illustrated in FIG. 10, a part of the large area is used or displayed for forming a composite image as the output image Im.

The ECU 11 can change a display area Ad of the output image Im and the vehicle exterior image Imo in accordance with a condition of the vehicle 1. The ECU 11 can use results of detection from various types of sensors or command signals as data or a trigger signal for changing the display area Ad. Examples of the detection result include detection results from a non-contact measuring unit 13, a front-wheel steering angle sensor 14, a steering angle sensor 15a of a rear-wheel steering system 15, a global positioning system (GPS) 16, a wheel speed sensor 17, a brake sensor 18a of a brake system 18, an accelerator sensor 19, a torque sensor 20a of a front-wheel steering system 20, and a shift sensor 21, which are illustrated in FIG. 1. Examples of the command signal include command signals acquired from a direction indicator 22 and an operation input 24b. The command signal can also be referred to as, for example, a control signal, a switching signal, an operation signal, an input signal, or command data. The display area Ad can also be referred to as an area from which the output image Im and the vehicle exterior image Imo originate.

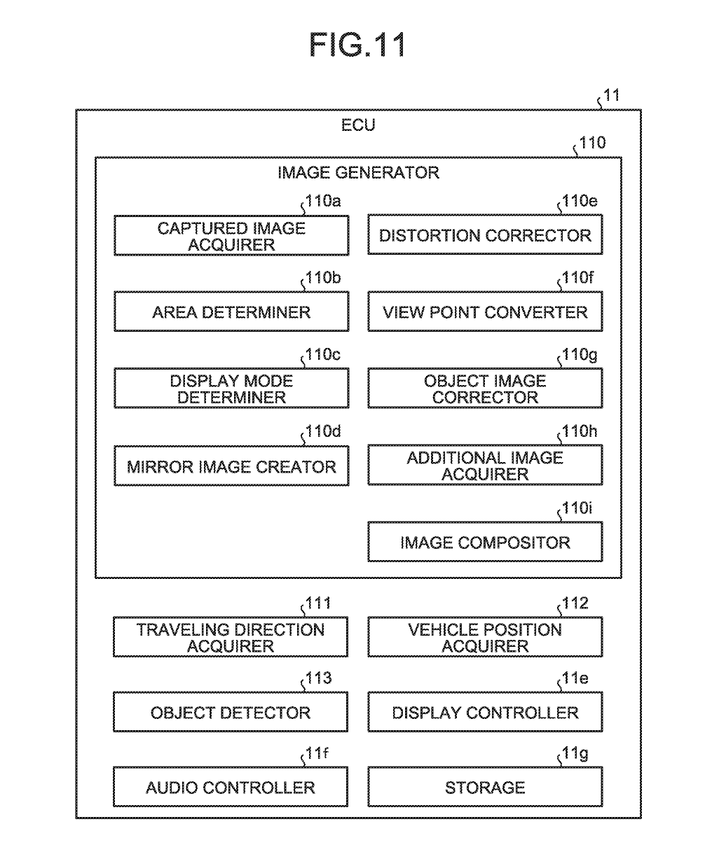

The ECU 11 can set or change the display area Ad of the output image Im and the vehicle exterior image Imo, and the transmittance α, the color (hue), the luminance, and the chroma of the vehicle body image Imi in accordance with the traveling direction of the vehicle 1 acquired by a traveling direction acquirer 111, the position of the vehicle 1 acquired by a vehicle position acquirer 112, a result of detection by an object detector 113, which are illustrated in FIG. 11. With use of the vehicle body image Imi of the line drawing, the ECU 11 may set or change the thickness of the contour lines Lo or shading or non-shading in the vehicle body image Imi.

Electric components of the image display system 100 are connected to each other electrically or in a communicable manner through, for example, an in-vehicle network 23, as illustrated in FIG. 1. Examples of the electric components include the non-contact measuring unit 13, the steering angle sensor 14, the steering angle sensor 15a, the GPS 16, the wheel speed sensor 17, the brake sensor 18a, the accelerator sensor 19, the torque sensor 20a, the shift sensor 21, the direction indicator 22, and the operation input 24b. The in-vehicle network 23 is, for example, a controller area network (CAN). The respective electric components may be connected to each other electrically or in a communicable manner through a network other than the CAN.

The non-contact measuring unit 13 is, for example, a sonar or a radar that outputs ultrasonic waves or electric waves to capture their reflected waves. The ECU 11 can detect presence or absence of the object B as an obstacle around the vehicle as illustrated in FIG. 21 and measure a distance to the object B based on a result of the detection from the non-contact measuring unit 13. That is to say, the non-contact measuring unit 13 is an example of a range finder and an object detector.

The steering angle sensor 14 is a sensor that detects the steering amount of a steering wheel (not illustrated) as a steering element and is formed of, for example, a hall element. The steering angle sensor 15a is a sensor that detects the steering amounts of rear wheels 3R and is formed of, for example, a hall element. The steering amount is detected as, for example, a rotational angle.

The wheel speed sensor 17 is a sensor that detects the rotation amounts or the rotation rate per unit time of the wheels 3 (3F and 3R) and is formed of, for example, a hall element. The ECU 11 can calculate the travel amount of the vehicle 1 based on data acquired from the wheel speed sensor 17. The wheel speed sensor 17 may be provided in the brake system 18.

The brake system 18 is an anti-lock brake system (ABS) that prevents locking of the brake, an electronic stability control (ESC) that prevents a skid of the vehicle 1 during cornering, an electric brake system that increases braking force, or a brake by wire (BBW), for example. The brake system 18 applies braking force to the wheels 3 through actuators (not illustrated) to decrease the speed of the vehicle 1. The brake sensor 18a is, for example, a sensor that detects the operation amount of a brake pedal.

The accelerator sensor 19 is a sensor that detects the operation amount of an accelerator pedal. The torque sensor 20a detects torque applied to the steering element by a driver. The shift sensor 21 is, for example, a sensor that detects the position of a movable part of a gear shifter and is formed of a displacement sensor, for example. The movable part is, for example, a lever, an arm, or a button. The configurations, placement, and electric connections of the various kinds of sensors and actuators as above are merely examples and can be variously set or changed. The direction indicator 22 outputs signals for indicating turning-on, turning-off, or blinking of the lights for direction indication.

The display 10a can be covered by the transparent operation input 10b. The operation input 10b is, for example, a touch panel. The occupant can view an image displayed on the screen of the display 10a through the operation input 10b. The occupant can execute various operation inputs on the image display system 100 by touching, pressing, and moving a position on the operation input 10b corresponding to the image displayed on the screen of the display 10a with his or her hand or finger. Another operation input 10c may be provided in the housing 10 in addition to the operation input 10b. In this case, the operation input 10c can be configured as, for example, a push button, a switch, or a knob.

A display 24a different from the display 10a and an audio output 24c are provided in the vehicle. The display 24a is, for example, a liquid crystal display (LCD) or an organic electroluminescence display (OELD). The audio output 24c is, for example, a speaker. The display 24a is covered by a transparent operation input 24b. The operation input 24b is, for example, a touch panel. The occupant can view an image displayed on the screen of the display 24a through the operation input 24b. The occupant can execute operation inputs by touching, pressing, and moving a position on the operation input 24b corresponding to the image displayed on the screen of the display 24a with his or her hand or finger. The display 24a, the operation input 24b, and the audio output 24c can be included, for example, in a monitor unit 24 located in the vehicle-width or horizontal center of a dashboard. The monitor unit 24 can include operation inputs (not illustrated) such as a switch, a dial, a joy stick, and a push button. The monitor device 24 can also be utilized as a navigation system and an audio system. The ECU 11 can display, on the display 24a of the monitor unit 24, a similar image to that on the display 10a.

The ECU 11 includes, for example, a central processing unit (CPU) 11a, a read only memory (ROM) 11b, a random access memory (RAM) 11c, the SSD 11d, a display controller 11e, and an audio controller 11f. The SSD 11d may be a flash memory. The CPU 11a can execute various calculations. The CPU 11a can read out a program installed and stored in a non-volatile storage such as the ROM 11b and the SSD 11d and execute calculations in accordance with the program. The RAM 11c temporarily stores therein various kinds of data to be used in the calculations by the CPU 11a. The SSD 11d is a rewritable non-volatile storage and can store therein data even during the power-off of the ECU 11. Among the calculations by the ECU 11, the display controller 11e can mainly execute image processing based on image data acquired by the imager 12 and image processing on image data displayed on the displays 10a and 24a. The audio controller 11f can mainly execute processing on audio data output from the audio output 24c among the calculations by the ECU 11. The CPU 11a, the ROM 11b, and the RAM 11c can be integrated in the same package. The ECU 11 may include another logic operation processor such as a digital signal processor (DSP) or a logic circuit in place of the CPU 11a. Alternatively, it may include a hard disk drive (HDD) in place of the SSD 11d, and the SSD 11d and the HDD may be provided separately from the ECU 11.

In the embodiment, through the image processing by the ECU 11 the display 10a displays, for example, the output image Im corresponding to the mirror image of the room mirror. In this case, a function, a coefficient, a constant, and data for coordinates conversion from the vehicle exterior image Imo to the output image Im corresponding to a mapped image on the room mirror can be obtained by actually acquiring the actual positions of markers, which are disposed outside or inside the vehicle, in the mapped image on the room mirror, by calibration based on imaging or by geometric computations. The function may be a conversion equation or a conversion matrix. The output image Im is, for example, an image similar to the mapped image on the room mirror, an aligned image, or an adapted image. Moreover, a composite position, the size, and the shape of the vehicle body image Imi can also be obtained by actually acquiring the actual positions of the markers, which are disposed outside or inside the vehicle, in the mapped image on the room mirror, by calibration based on imaging, or by geometric computations.

In the embodiment, the ECU 11 functions as, for example, at least a part of the image display control device in cooperation with hardware and software (programs). In the embodiment, as illustrated in FIG. 11, the ECU 11 thus functions as, for example, an image generator 110, the traveling direction acquirer 111, the vehicle position acquirer 112, the object detector 113, a captured image acquirer 110a, an area determiner 110b, a display mode determiner 110c, a mirror image creator 110d, a distortion corrector 110e, a viewpoint converter 110f, an object image corrector 110g, an additional image acquirer 110h, and an image compositor 110i in addition to the display controller 11e and the audio controller 11f that are also illustrated in FIG. 1. The image generator 110 is, for example, the CPU 11a and a storage 11g is, for example, the SSD 11d. The storage 11g stores therein, for example, data to be used in calculations, and results of the calculations. The display controller 11e may execute at least a part of image processing executed by the image generator 110. The respective configurations in FIG. 11 may correspond to modules of the program or be hardware. The configuration of the ECU 11 illustrated in FIGS. 1 and 11 are exemplary.

The traveling direction acquirer 111 can acquire the traveling direction of the vehicle 1 from results of the detection from the shift sensor 21, the wheel speed sensor 17, and an acceleration sensor (not illustrated), and data from another ECU (not illustrated). The traveling direction acquirer 111 acquires the state of the vehicle 1, i.e., forward travel or backward travel.

The vehicle position acquirer 112 can acquire the position of the vehicle 1 based on, for example, the wheel speed detected by the wheel speed sensor 17, a steering angle detected by the steering angle sensors 14 and 15a, data from the GPS 16, a detection result from the non-contact measuring unit 13, a result of image processing on the vehicle exterior image Imo acquired by the imager 12, and data from another ECU (not illustrated). The position of the vehicle 1 may be, for example, a current position or a position relative to a target position of a parking assist system.

The object detector 113 can detect the object B outside the vehicle by, for example, image processing to the vehicle exterior image Imo created by the image generator 110. The object B is, for example, a vehicle, an object or a person. For example, the object B can be detected by pattern matching. The object detector 113 can detect the object B outside the vehicle from data from the non-contact measuring unit 13 as well as from the vehicle exterior image Imo subjected to the image processing, and data from the non-contact measuring unit 13. The object detector 113 may acquire the distance to the object B from the vehicle 1 from the vehicle exterior image Imo subjected to the image processing or the data from the non-contact measuring unit 13.

The captured image acquirer 110a acquires the vehicle exterior image Imo captured by at least one imager 12. With use of two or more imagers 12, the captured image acquirer 110a combines boundaries of a number of (for example, three) captured images by the imagers 12 to create a series of vehicle exterior images Imo.

The area determiner 110b determines the display area Ad of the vehicle exterior image Imo to be used for the output image Im. The area determiner 110b can set the display area Ad of the output image Im and the vehicle exterior image Imo based on, for example, the traveling direction of the vehicle 1 acquired by the traveling direction acquirer 111, the position of the vehicle 1 acquired by the vehicle position acquirer 112, and the detection result by the object detector 113. The area determiner 110b may determine the display area Ad based on detection results by other sensors and devices, signals, data, and the like. Examples of other sensors and devices include the non-contact measuring unit 13, the steering angle sensors 14 and 15a, the GPS 16, the wheel speed sensor 17, the brake sensor 18a, the accelerator sensor 19, the torque sensor 20a, the shift sensor 21, and the direction indicator 22.

The display mode determiner 110c determines the display mode of the output image Im on the displays 10a and 24a. The display mode determiner 110c can set or change the display mode of the output image Im based on, for example, the traveling direction of the vehicle 1 acquired by the traveling direction acquirer 111, the position of the vehicle 1 acquired by the vehicle position acquirer 112, and the detection result by the object detector 113. The display mode determiner 110c may set or change the display mode of the output image Im based on detection results by other sensors and devices, signals, data, and the like. Examples of other sensors and devices include the non-contact measuring unit 13, the steering angle sensors 14 and 15a, the GPS 16, the wheel speed sensor 17, the brake sensor 18a, the accelerator sensor 19, the torque sensor 20a, the shift sensor 21, and the direction indicator 22. The display mode determiner 110c can set or change, for example, the transmittance α, the color, the luminance, or the chroma of the vehicle body image Imi. When a composite image contains an interior image, the display mode determiner 110c can set or change the transmittance of the interior image, for example.

The mirror image creator 110d can create a mirror image of the captured image, the vehicle exterior image Imo, or the output image Im. As long as the output image Im contains the vehicle exterior image Imo, the vehicle body image Im, or an additional image as the mirror image of the captured image, the mirror image creator 110d may create the mirror image at any stage.

The distortion corrector 110e corrects distortion of the captured image by the imager 12. When the imager 12 is a wide-angle lens or a fisheye lens, the image exhibits larger distortion as is farther from the center. The distortion corrector 110e corrects the captured image by coordinate conversion or interpolation, for example, so as to provide an image which gives less strangeness when displayed with a rectangular angle of view. The coordinate conversion is made by, for example, mapping or functions. Examples of the coordinate conversion for the distortion correction include cylindrical projection conversion for cylindrical projection and equidistant projection conversion by which a circumferential distance corresponds to an image height. The distortion corrector 110e is an example of an image corrector and a first image corrector.

The viewpoint converter 110f converts a viewpoint of the captured image by the imager 12. When there is a large difference between an imaging point of the imager 12 and a viewpoint of the mapped image on the room mirror, for example, the viewpoint converter 110f corrects the captured image by coordinate conversion or interpolation, for example, to obtain an image from a viewpoint closer to the viewpoint more forward, for example, the viewpoint of the mapped image on the room mirror, which gives less strangeness. The coordinate conversion is made by, for example, mapping or functions. The viewpoint converter 110f executes different image processing from that by the distortion corrector 110e. The viewpoint converter 110f can also provide the same effects as those of viewpoint conversion by correcting a tilt of an image by, for example, horizontally expanding the image or horizontally expanding the image more greatly toward the bottom of the image. The viewpoint converter 110f is an example of the image corrector and a second image corrector that executes different correction from the correction by the first image corrector. The correction to the vehicle exterior image Imo by the distortion corrector 110e and the viewpoint converter 110f does not need to be completely aligned with the mirror image on the room mirror.

The object image corrector 110g corrects an image of the object contained in the vehicle exterior image Imo. When, for example, the object detector 113 detects the object B such as another vehicle from the vehicle exterior image Imo including an image thereof, the object image corrector 110g can enlarge the image of another vehicle in the vehicle exterior image Imo.

The additional image acquirer 110h acquires a different image from the vehicle exterior image Imo from the output image Im. In the embodiment, an image among images contained in the output image Im other than the vehicle exterior image Imo is referred to as an additional image. Examples of the additional image include various kinds of images such as the vehicle body image Imi, images of frame lines on the road surface, images of objects, an image representing the traveling direction, an image representing a target position, an image representing a previous trajectory, a highlighted object detected by the object detector 113, and text images. The additional image acquirer 110h can further acquire additional images corresponding to, for example, the traveling direction acquired by the traveling direction acquirer 111, the position of the vehicle 1 acquired by the vehicle position acquirer 112, the object detected by the object detector 113, the display area Ad determined by the area determiner 110b, and the display mode determined by the display mode determiner 110c. The additional image acquirer 110h may acquire, as the additional image, an interior image of the vehicle cabin by the imager 121 (see FIGS. 8 and 9 and other drawings). For example, the storage 11g can store therein the additional images. For example, the storage 11g can store therein data for specifying the additional images according to values of respective parameters.

The image compositor 110i combines the vehicle exterior image Imo and the additional image to generate the output image Im. When the additional image is an interior image, the image compositor 110i can superimpose a transparent interior image with windows removed by image processing.

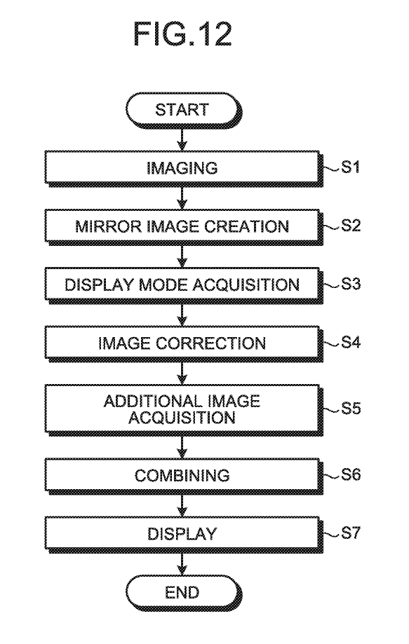

The image display system 100 in the embodiment can execute processing in order as illustrated in FIG. 12, for example. First, the captured image acquirer 110a acquires an image captured by the imager 12 (S1). Then, the mirror image creator 110d creates a mirror image of the captured image by the imager 12 (S2). Subsequently, the distortion corrector 110e and the viewpoint converter 110f acquire a display mode set by the display mode determiner 110c (S3) and correct the vehicle exterior image Imo according to the acquired display mode (S4). The additional image acquirer 110h then acquires an additional image (S5) and the image compositor 110i combines the additional image acquired by the additional image acquirer 110h and the vehicle exterior image Imo to obtain the output image Im (S6). Next, the display controller 11e controls the display 10a to display the output image Im (S7).

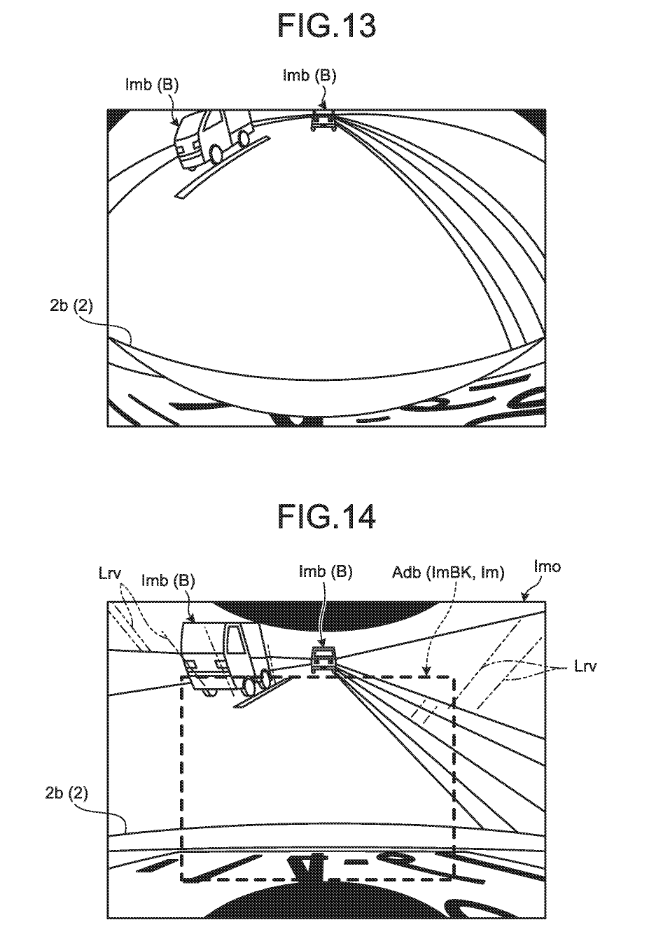

As illustrated in FIG. 13, the captured image by the imager 12R has larger distortion as is farther from the center. In the embodiment, the distortion corrector 110e corrects the captured image in FIG. 13 to create the vehicle exterior image Imo with reduced distortion as illustrated in FIG. 14. The coordinate conversion herein is made by, for example, mapping or functions. Luminance values (pixel values) of blank pixels on coordinates of a conversion destination are calculated by interpolation from luminance values of adjacent pixels. The correction by the distortion corrector 110e makes curved lines, which are distorted straight lines, closer to straight lines.

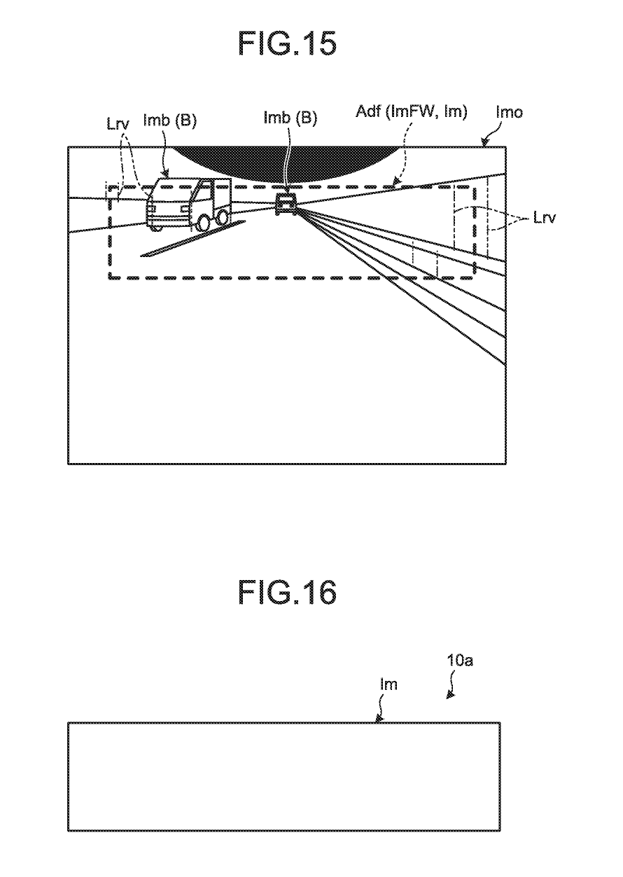

In the periphery of the vehicle exterior image Imo in FIG. 14, actually vertical lines Lry as indicated by dashed lines are inclined so as to extend horizontally with respect to the vertical direction of the screen. In the embodiment, the viewpoint converter 110f corrects the vehicle exterior image Imo in FIG. 14 to obtain the vehicle exterior image Imo with the inclination corrected, the actually vertical lines Lry corrected to be closer to be vertical, as illustrated in FIG. 15. This coordinate conversion is also made by, for example, mapping or functions. Luminance values (pixel values) of blank pixels on coordinates of a conversion destination are calculated by interpolation from luminance values of adjacent pixels. The correction by the viewpoint converter 110f decreases the inclinations of the actually vertical lines Lry with respect to the vertical direction of the screen.

In the embodiment, for example, an output image ImBK (Im) during backward travel is created based on the vehicle exterior image Imo corrected by the distortion corrector 110e as illustrated in FIG. 14. An output image ImFW (Im) during forward travel is created based on the vehicle exterior image Imo corrected by the distortion corrector 110e and the viewpoint converter 110f as illustrated in FIG. 15. For example, calculation load on the image generator 110 can be thus reduced during the backward travel of the vehicle 1.

In the embodiment, a display area Adb of the output image ImBK during the backward travel is, for example, set to a region of the distortion-corrected vehicle exterior image Imo in FIG. 14 relatively close to the rear of the vehicle body 2 that contains the image of the rear end 2b of the vehicle body 2. On the other hand, a display area Adf of the output image ImFW during the forward travel is set to a region of the distortion-corrected and viewpoint-converted vehicle exterior image Imo in FIG. 15 relatively farther from the rear end 2b of the vehicle body 2, that is, a region farther than the region set during the backward travel. The display area Adf is set to be horizontally larger than the display area Adb set in the backward travel. As described above, according to the embodiment, the ECU 11 can obtain, for example, the vehicle exterior image Imo (output image ImFW) during the forward travel and the vehicle exterior image Imo (output image ImBK) during the backward travel from the captured image by the imager 12. The configuration of the image display system 100 can be further simplified from the one including separate imagers 12 for the forward travel and the backward travel because of use of common components, for example. The ECU 11 can obtain different vehicle exterior images Imo in conformity with situations in the forward travel and the backward travel. The display areas Adb and Adf can also be referred to as areas from which the vehicle exterior images Imo originate.

In the embodiment, the ECU 11 can display the output image Im in various display areas in various display modes as illustrated in FIGS. 16 to 18, 20, and 21. FIGS. 16 to 18, 20, and 21 illustrate only display regions of the respective output images Im and do not illustrate specific images.

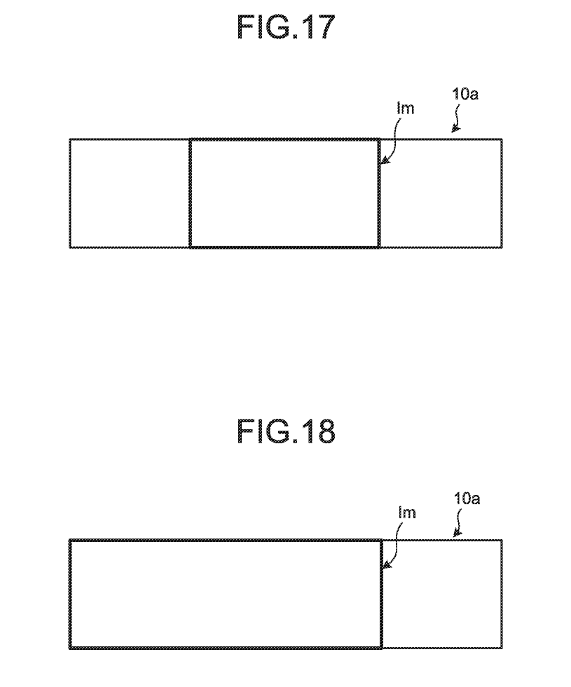

FIG. 16 shows the example that the output image Im is displayed on the entire screen of the display 10a. FIG. 17 shows the example that the output image Im is displayed on a part, specifically, on a horizontal center of the display 10a. In the embodiment, the ECU 11 can control the display 10a to, for example, display the output image Im as illustrated in FIG. 16 during the forward travel and display the output image Im as illustrated in FIG. 17 during the backward travel. That is to say, the output image Im in the forward travel is larger than the output image Im in the backward travel. The horizontal length or the width of the output image Im in the forward travel is larger than that of the output image Im in the backward travel, and a ratio of the horizontal length or width thereof to the vertical length or height thereof is higher than that in the backward travel. There may be a case, for example, in which a horizontally large area is not needed for the backward travel for parking as much as for the forward travel, or may be a case in which a large viewing area decreases the attention of the occupant to a near area. A narrower display area brings the effects of, for example, reduced calculation load on the ECU 11 and reduced power consumption. According to this example, changing the settings of the display area and the display mode for the forward travel and the backward travel may attain less inconvenient display area and display mode, for example. In the example of FIG. 17, the ECU 11 may control the display 10a to display other pieces of information such as text information on both lateral regions of the output image Im.

Furthermore, the ECU 11 may expand the output image Im in the turning direction of the vehicle 1 when the vehicle 1 moves backward while turning for parking. FIG. 18 shows the example that the output image Im is displayed in a region from the center to the left end of the display 10a, that is, to an end in the turning direction when the vehicle 1 moves backward to a certain parking lot while turning leftward. In this case, for example, the ECU 11 can switch the output image Im in FIG. 17 to the output image Im in FIG. 18 that is extended leftward or in the turning direction relative to the output image Im in FIG. 17 when determining that a steering angle is equal to or larger than a predetermined steering angle (threshold) from a detection result from the steering angle sensor 14. With this example, the display of the extended output image Im enables the occupant as a driver to easily see the travel direction of the vehicle 1 such as a target parking position, for example. It also can effectively help reduce the calculation load on the ECU 11 and power consumption from that of the output image Im extended in both the turning direction and the opposite direction, for instance.

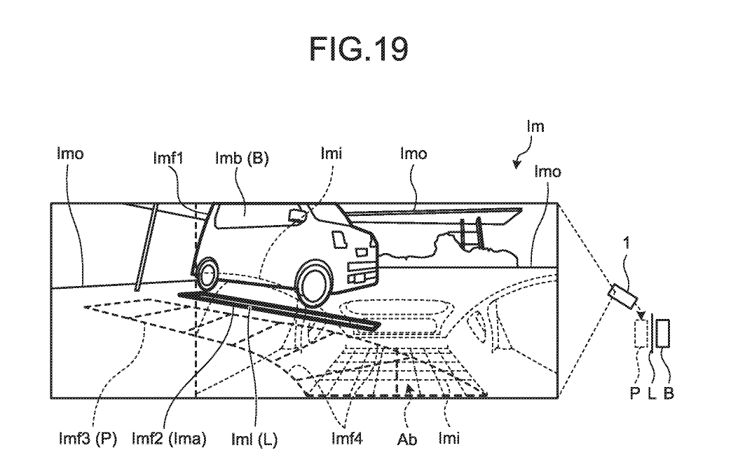

FIG. 19 illustrates the output image Im when, for example, the vehicle 1 moves backward to an estimated reaching position while turning to the left side for parking. FIG. 19 illustrates a more specific example of FIG. 18. In this example, the vehicle exterior image Imo additionally includes the vehicle body image Imi, an image Imb of the detected object B, highlighted frame-like display Imf1 surrounding the image Imb, an image Iml of a frame line L on the road, a highlighted band-like display Imf2 superposed on the image Iml, an image Imf3 representing the estimated reaching position backward from a current position by a predetermined distance, and linear images Imf4 indicating travel paths estimated from the estimated reaching position and the steering angle. The images Imf3 and Imf4 correspond to a display region Ab corresponding to the lower part of the vehicle body 2 in the vehicle body image Imi. For example, the side edges of the images Imf3 and Imf4 can be drawn so as to match the side edges of the display region Ab at the estimated reaching position. According to this example the driver can know the surrounding of the vehicle 1, situations outside the vehicle in the traveling direction, the target parking position P, the estimated reaching position, and the travel path, for example. Furthermore, according to the embodiment, for example, the occupant such as a driver can grasp the estimated travel path of the vehicle 1 from the vehicle body image Imi containing the display region Ab and the images Imf3 and Imf4 corresponding to the display region Ab.

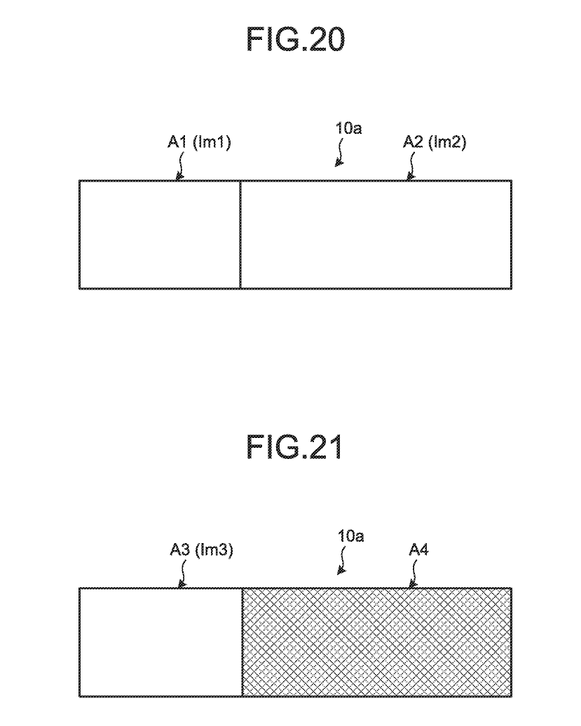

FIG. 20 illustrates an example of simultaneously displaying, on the display 10a, two output images Im (Iml and Im2) having different display areas Ad of the captured image adjacent to each other. In this case, the ECU 11 controls the display 10a, for example, to display, in a left region A1, the output image Iml corresponding to the display area Adb closer to the road surface illustrated in FIG. 14 and to display, in a right region A2, the output image Im2 corresponding to the more horizontal display area Adf illustrated in FIG. 15. The region A1 or the output image Iml is smaller than the region A2 or the output image Im2. The horizontal length or width of the region A1 is smaller than that of the region A2, and a ratio of the horizontal length or width thereof to the vertical length or height thereof is lower than that of the region A2. The region A1 of the captured image or the area of the output image Iml is larger in the vehicle longitudinal direction, is smaller in the vehicle width direction, and is closer to the vehicle 1 than the region A2 or the area of the output image Im2. According to this example, the occupant as a driver may easily understand a situation from the output images Im (Im1 and Im2), for example. The arrangement, areas in the captured image, and sizes of the regions A1 and A2 or the output images Iml and Im2 are not limited to those in the example in FIG. 20 and can be variously set or changed. Setting may be changeable through operation input to the operation input 10b, 10c, or 24b by the occupant such as a driver.

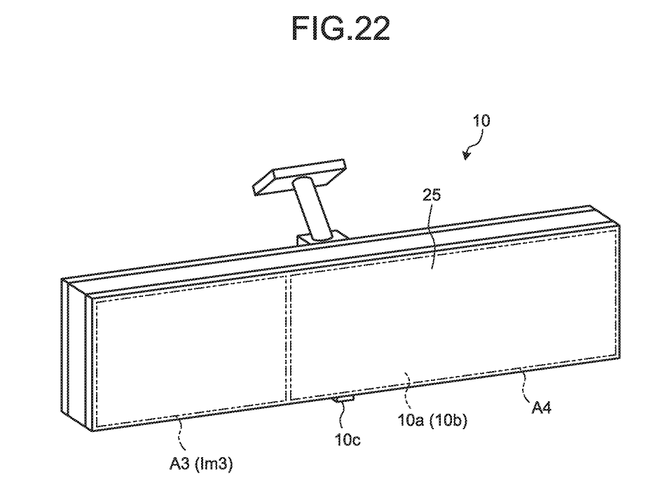

FIG. 21 illustrates an example of displaying an output image Im3 on a region A3 of the display 10a and blackening out or darkening a region A4, that is, displaying no output image Im, for example. The ECU 11 controls the display 10a to display the output image Im3 in the region A3 and blacken out the region A4. The region A3 or the output image Im3 is, for example, the same as the region A1 or the output image Iml in the example of FIG. 20. In the case of providing a half mirror on the front surface, that is, the rear side of the display 10a, the front surface of the display 10a that corresponds to the region A4 functions as a room mirror (mirror). That is to say, as illustrated in FIG. 22, the output image Im3 is displayed on the region A3 of the display 10a provided on the surface (rear surface) of the housing 10, and no output image Im is displayed on the region A4 which functions as a mirror. According to this example, the occupant such as the driver may easily understand a situation from the output image Im3 displayed on the region A3 and an actual mirror image (mapped image) on the region A4, for example. The arrangement, areas in the captured image, and sizes of the regions A3 and A4 or the output image Im3 and the mirror image (mapped image) on the half mirror are not limited to those in the example of FIGS. 21 and 22 and can be variously set or changed. Setting may be changeable by operation input to the operation input 10b, 10c, or 24b by the occupant such as the driver.

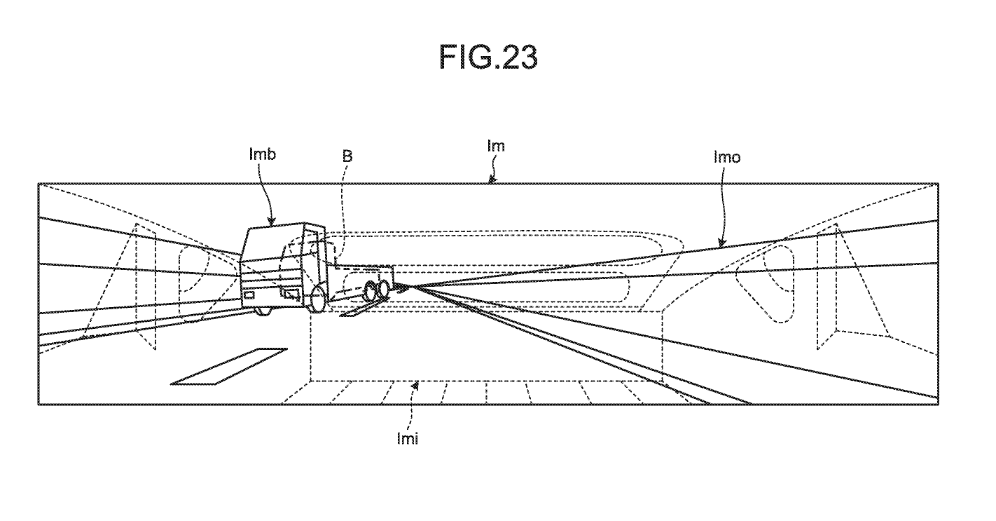

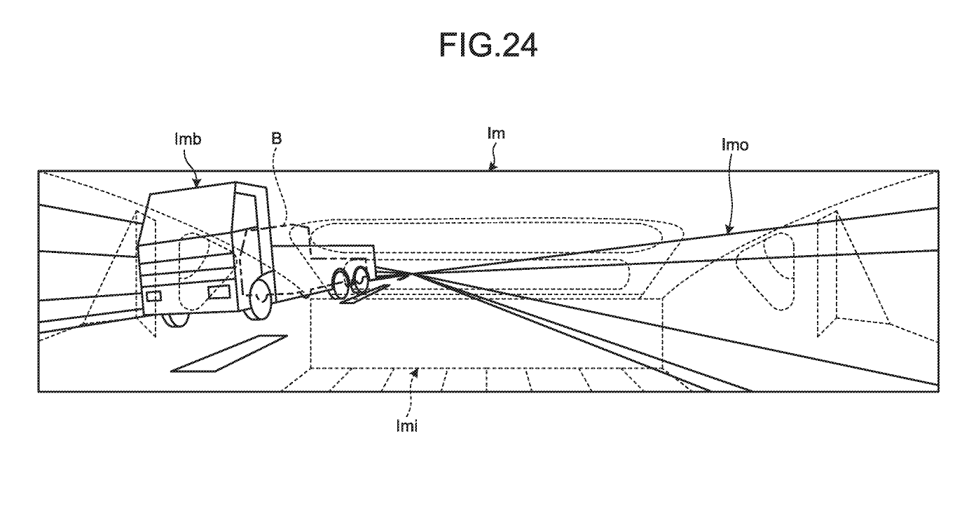

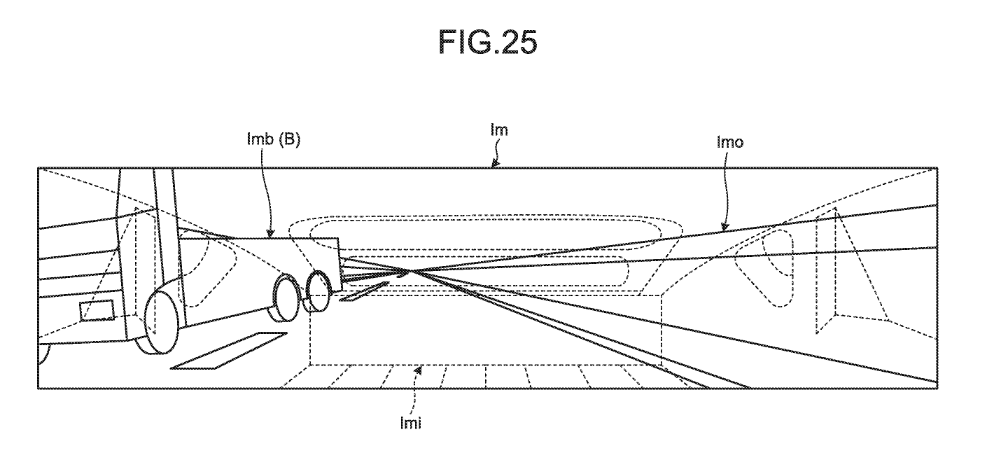

FIGS. 23 to 25 illustrate examples of corrected images Imb of the object B such as another vehicle by the object image corrector 110g. FIG. 23 illustrates the example when the object B is farthest from the vehicle 1, FIG. 24 illustrates the example when the object B approaches the vehicle 1 from the position in FIG. 23, and FIG. 25 illustrates the example when the object B further approach the vehicle 1 than in FIG. 24. Each of the output images Im in FIGS. 23 to 25 contains the vehicle exterior image Imo corrected by the distortion corrector 110e and the viewpoint converter 110f. The ECU 11 can obtain a distance between the object B and the vehicle 1 from the vehicle exterior image Imo resulting from the image processing and a detection result from the non-contact measuring unit 13. In this case, the ECU 11 extracts the image Imb of the object B from the vehicle exterior image Imo by image processing and controls the display 10a to further enlarge the image Imb of the object B for display as the distance from the vehicle 1 to the object B increases. In FIG. 23, the image Imb of the object B is enlarged double the size of the original image of the object B that is indicated by the two-dot chain lines in the drawing. In the FIG. 24, the image Imb of the object B is enlarged 1.5 times the size of the original image of the object B that is indicated by the two-dot chain lines in the drawing. In FIG. 25, the image Imb of the object B is not enlarged. According to this example the occupant such as the driver can easily recognize the object B in a farther location, for example. The magnification factor based on the distance of the image Imb of the object B, the position of the enlarged image, and the display mode are not limited to the examples in FIGS. 23 to 25 and can be variously set or changed.

The area determiner 110b and the display mode determiner 110c can determine the areas and the display modes of the vehicle exterior image Imo, the vehicle body image Imi, the additional images, and the output image Im through operation input by the occupant such as the driver. In this case, for example, the occupant such as the driver can view the output image Im of a preferred area in a preferred display mode on the display 10a. The operation inputs are made through the operation to the operation input 10b, 10c, or 24b or the steering by the occupant such as the driver. The operation inputs based on the operation of the steering can be obtained from results of the detection by the steering angle sensor 14.

As described above, in the embodiment, for example, the area determiner 110b (area changer) changes the display area Ad (area) of the output image Im (display image) of the captured image for the forward travel and the backward travel of the vehicle 1. According to the embodiment, the display 10a (display device) can thus display the output image Im in the display area Ad that is appropriate for each of the forward travel and the backward travel of the vehicle 1. The occupant such as the driver can therefore see easily viewable output images Im or easily view the images of the object according to his or her condition. The display area Ad may be the same as or different from a correction area of the correctors such as the distortion corrector 110e and the viewpoint converter 110f. That is to say, the ECU 11 (image display control device) may correct pixels (image) in the display area Ad or may extract the display area Ad from the area of the corrected pixels (image).

In the embodiment, in the forward travel and the backward travel the vehicle exterior images Imo can be obtained from the captured images by one imager 12R, for example. This can further simplify the image display system 100, for example. The ECU 11 can perform image processing to the captured image by one imager 12R differently for the forward travel and the backward travel to thereby create the vehicle exterior images Imo, for example. For example, the occupant such as the driver can therefore see easily viewable output images Im or easily view the images of the object according to his or her condition.

In the embodiment, the distortion corrector 110e (image corrector) and the viewpoint converter 110f (image corrector), for example, correct the vehicle exterior image Imo in different modes during the forward travel and the backward travel of the vehicle 1. Thus, the display 10a can display, for example, the output image Im in the appropriate display mode for each of the forward travel and the backward travel of the vehicle 1. For example, the occupant such as the driver can therefore see easily viewable output images or easily view the images of the object according to his or her condition. In addition, correction or non-correction to the images and the correction modes are changed for the forward travel and the backward travel, which can reduce the calculation load on the ECU 11, for example.

In the embodiment, the area determiner 110b changes the size of the display area Ad for the forward travel and the backward travel of the vehicle 1, for example. The display 10a can hence display, for example, the output image Im of appropriate size for each of the forward travel and the backward travel of the vehicle 1. For example, the occupant such as the driver can therefore see easily viewable output image Im or easily view the images of the object according to his or her condition. Different magnifications of the output image Im may be set for the forward travel and the backward travel.

In the embodiment, the image generator 110 can generate, for example, the output image Im containing the vehicle exterior images Imo of different display areas Ad. The display 10a can thus display, for example, the output image Im containing the vehicle exterior images Imo. For example, the occupant such as the driver can hence view images of a larger number of objects. This can also help the occupant such as the driver view, for example, the entire image from the second output image Im2 of the wider display area Ad and see details from the first output image Im1 of the narrower display area Ad. Thereby, the occupant such as the driver may know the conditions of the vehicle 1 more easily, more rapidly, or more accurately.

In the embodiment, the respective vehicle exterior images Imo contained in the output image Im are, for example, corrected images in different modes by the image generator 110. This, for example, makes it easier for the occupant such as the driver to view the output images Im and to recognize the images of the object. In addition, correction or non-correction of the output images Im or change of correction mode is made for each of the output images Im, which can reduce the calculation load on the ECU 11.

In the embodiment, for example, the half mirror 25 covers the display 10a (display device), and the display controller 11e controls the display 10a to display the output image Im on a part of the display 10a and blacken out another part of the display 10a, causing the half mirror 25 to function as a mirror. The display 10a can thus be utilized as, for example, a display and a mirror.

That is, by the relatively simple configuration and control, the display 10a can provide, for example, a plurality of viewable states of images (output image Im and mapped image) to the occupant such as the driver.

In the embodiment, the display controller 11e controls the display 10a, for example, to display the output image Im at different positions for the forward travel and the backward travel of the vehicle 1. For example, the occupant such as the driver can therefore see easily viewable output images Im or easily view the images of the object according to his or her condition.

In the embodiment, the image generator 110, for example, adds different additional images such as the vehicle body image Imi in the forward travel and the backward travel of the vehicle 1. For example, the occupant such as the driver can therefore see easily viewable output images Im or view the images of the object according to his or her condition.

Although the embodiment of the present invention has been described above, the embodiment is merely exemplary and is not intended to limit the scope of the invention. The embodiment can be implemented in other various modes and various omissions, replacements, combinations, and changes can be made in a range without departing from the gist of the invention. Furthermore, the configurations and the shapes of the respective examples can be partially replaced for implementation. Specification such as configurations and shapes (structures, types, directions, shapes, sizes, lengths, widths, thicknesses, heights, numbers, arrangement manners, positions, colors, patterns, and the like) can be appropriately changed for implementation. The correction may be, for example, correction other than the distortion correction and the viewpoint conversion. Furthermore, the order of the calculations in the correction processing and the like can be appropriately changed.

The output image (display image) may be displayed on two or more display devices or on a display device other than that on the room mirror. The display device may be a device that reflects an image onto a front window, an in-vehicle screen, or the like. The display device may be a display panel provided on an in-vehicle dashboard, a center console, or the like. The display panel may be provided on a cockpit module, an instrument panel, a fascia, or the like.

For example, the vehicle exterior image may be obtained from the composite image of captured images by two or more imagers during the forward travel whereas the vehicle exterior image may be obtained from a captured image by one imager during the backward travel. That is to say, the imager that obtains captured images (vehicle exterior image) during the forward travel may differ from the imager that obtains captured images (vehicle exterior image) during the backward travel. This can provide easily viewable display images and further reduce the calculation load.

### EXPLANATIONS OF LETTERS OR NUMERALS

1 VEHICLE
2 VEHICLE BODY
2b REAR END
10a DISPLAY (DISPLAY DEVICE)
11 ECU (IMAGE DISPLAY CONTROL DEVICE)
11e DISPLAY CONTROLLER
12, 12R IMAGER
25 HALF MIRROR
100 IMAGE DISPLAY SYSTEM
110 IMAGE GENERATOR
110b AREA DETERMINER (AREA CHANGER)
110e DISTORTION CORRECTOR (IMAGE CORRECTOR)
110f VIEWPOINT CONVERTER (IMAGE CORRECTOR)
Ad DISPLAY AREA (AREA)
Im, Im1, Im2, Im3 OUTPUT IMAGE (DISPLAY IMAGE)
Imo VEHICLE EXTERIOR IMAGE
Lrh HORIZONTAL DIRECTION

1. An image display control device comprising:
an image generator configured to generate a display image to be displayed on a display device, the display image containing a vehicle exterior image based on at least a part of a captured image by an imager, an imaging area of the imager being from a direction in which a rear end of a vehicle body can be captured to a direction upward from a horizontal direction and a rearward of a vehicle;
an area changer configured to change an area of the captured image to be contained in the display image for forward travel and backward travel of the vehicle; and
a display controller configured to control the display device to display the display image.

2. The image display control device according to claim 1, wherein the captured image is captured by one imager.

3. The image display control device according to claim 1, further comprising an image corrector configured to correct the vehicle exterior image in different modes for the forward travel and the backward travel of the vehicle.

4. The image display control device according to claim 1, wherein the area changer changes a size of the area for the forward travel and the backward travel of the vehicle.

5. The image display control device according to claim 1, wherein the image generator is capable of generating the display image containing a plurality of the vehicle exterior images having different areas.

6. The image display control device according to claim 1, wherein
the display device is covered by a half mirror, and
the display controller controls the display device to display the display image on a part of the display device, and blacken out another part of the display device to cause the half mirror to function as a mirror.

7. An image display system comprising:
an imager an imaging area of which is from a direction in which a rear end of a vehicle body can be captured to a direction upward from a horizontal direction and a rearward of a vehicle;
a display device; and
an image display control device,
the image display control device including:
an image generator configured to generate a display image to be displayed on the display device, the display image containing a vehicle exterior image based on at least a part of a captured image by the imager;
an area changer configured to change an area of the captured image to be contained in the display image for forward travel and backward travel of the vehicle; and
a display controller configured to control the display device to display the display image.
